(19) United States
(12) Patent Application Publication
(10) Pub. No.: US 2019/0118607 A1
(43) Pub. Date: Apr. 25, 2019

(54) DYNAMIC HEAVY-DUTY VEHICLE SUSPENSION ARRANGEMENT

(71) Applicant: SAF-HOLLAND, Inc., Muskegon, MI (US)

(72) Inventor: Randy L. Schutt, Holland, MI (US)

(21) Appl. No.: 16/161,952

(22) Filed: Oct. 16, 2018

Related U.S. Application Data
(60) Provisional application No. 62/574,501, filed on Oct. 19, 2017.

(51) Int. Cl. B60G 17/052; B60G 5/04; B60G 11/27; B60G 7/00

(52) U.S. Cl. CPC B60G 17/0521; B60G 5/04; B60G 11/27; B60G 7/001; B60G 2200/31; B60G 2202/152; B60G 2300/042; B60G 2400/10; B60G 2400/0511; B60G 2400/60; B60G 2400/102; B60G 2400/252; B60G 2400/7122

(57) ABSTRACT

A vehicle suspension arrangement includes mounting brackets configured to couple to a vehicle frame assembly, trailing arms coupled to the mounting brackets, a first axle member coupled to the trailing arms, an air spring arrangement coupled to the vehicle frame assembly and one of the trailing arms, and an air spring arrangement, wherein the first end, the second end and the air spring arrangement cooperate to define an interior space, a second axle member spaced from the first axle member, a sensor arrangement position within the interior space and configured to sense an operational parameter of the air spring arrangement, and a control arrangement operably coupled to the sensor arrangement and configured to receive information from the first sensor arrangement, wherein the control arrangement is configured to control at least one operational characteristic of the second axle member based upon the information received from the sensor arrangement.

### CROSS-REFERENCE TO RELATED APPLICATIONS

This application claims the benefit of U.S. Provisional Patent Application No. 62/574,501, filed on Oct. 19, 2017, entitled “DYNAMIC HEAVY-DUTY SUPSPENSION ARRANGEMENT,” the entire disclosure of which is incorporated herein by reference.

### BACKGROUND

The embodiments as disclosed herein relate to a vehicle suspension arrangement, and in particular to a vehicle suspension arrangement that includes a pair of tandem axle members and a dynamic suspension arrangement operably coupling the axle members to a vehicle frame assembly, wherein the suspension arrangement includes a sensor arrangement configured to monitor the operational parameters of the first axle member and control the operational characteristics of the second axle member based on the monitored operational parameters.

### BRIEF SUMMARY

One embodiment provides a vehicle suspension arrangement that includes a first mounting bracket and a second mounting bracket each configured to couple to a vehicle frame assembly, a first trailing arm having a first end pivotably coupled to the first mounting bracket, and a second end, a second trailing arm having a first end pivotably coupled to the second mounting bracket, and a second end, a first axle member coupled to the second end of the first trailing arm and the second end of the second trailing arm, a first air spring arrangement having a first end configured to couple to the vehicle frame assembly and a second end operably coupled to the second end of the first trailing arm, and a bladder extending between the first end and the second end, wherein the first end, the second end and the bladder cooperate to define an interior space of the first air spring arrangement, and a second axle member spaced from the first axle member. The embodiment further includes a first sensor arrangement position within the interior space of the first air spring arrangement, wherein the first sensor arrangement is configured to sense an operational parameter of the first air spring, and a control arrangement operably coupled to the first sensor arrangement and configured to receive information from the sensor arrangement, wherein the control arrangement is configured to control at least one operational characteristic of the second axle based upon the information received from the first sensor arrangement.

Another embodiment includes a heavy duty vehicle suspension arrangement that includes a first axle member, a first spring arrangement operably coupling a first end of the first axle member with a vehicle frame assembly, a second axle member, a first sensor arrangement position operably coupled to the first spring arrangement, wherein the first sensor arrangement is configured to sense an operational parameter of the first air spring, and a control arrangement operably coupled to the first sensor arrangement and configured to receive information from the sensor arrangement, wherein the control arrangement is configured to control at least one operational characteristic of the second axle based upon the information received from the first sensor arrangement.

The principal objects of the embodiments as disclosed herein provide a durable suspension assembly that is efficient in use, capable of a long operating life, provides real-time feedback of suspension component operational parameters thereby allowing dynamic adjustment of operational characteristics of other components of the suspension arrangement, and is particularly well adapted for the proposed use. These and other advantages of the embodiments as described herein will be further understood and appreciated by those skilled in the art by reference to the following specification, claims and appended drawings.

### BRIEF DESCRIPTION OF THE DRAWINGS

FIG. 1 is a side elevational view of a truck and trailer vehicle arrangement that includes the a dynamic, heavy-duty vehicle suspension assembly or arrangement; and

FIG. 2 is a perspective view of the vehicle suspension arrangement.

### DETAILED DESCRIPTION

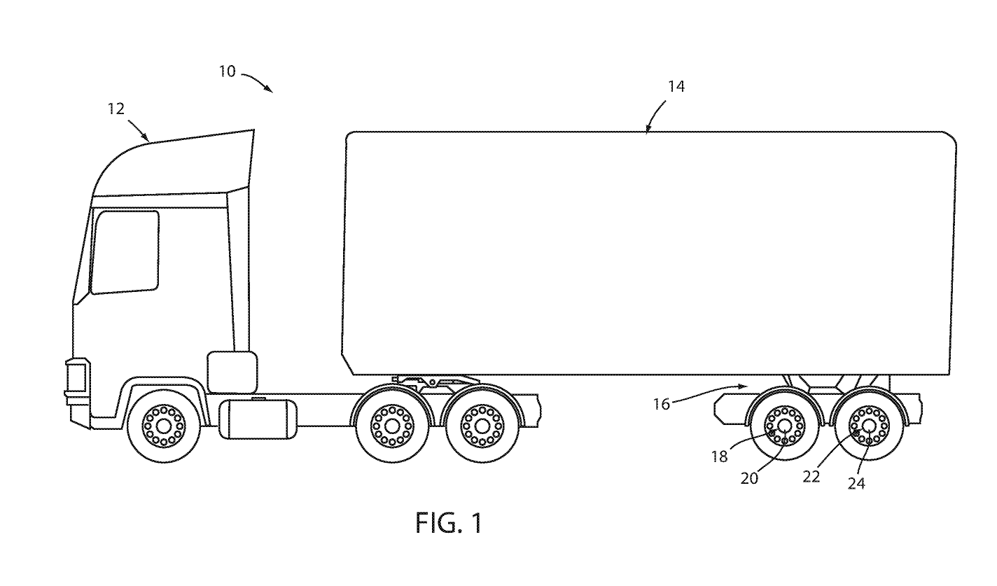

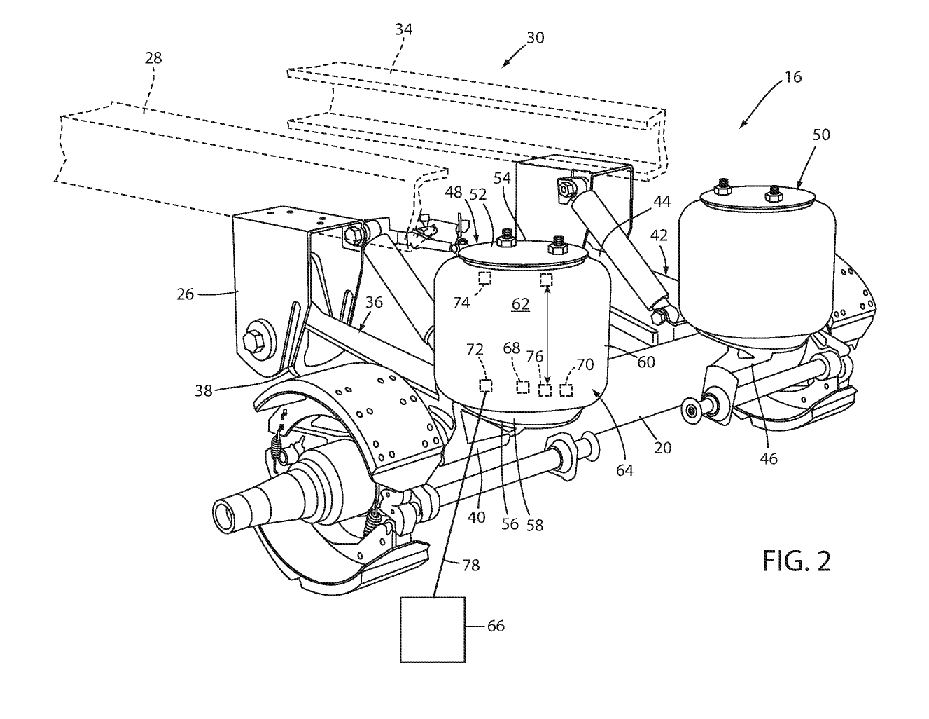

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

The reference numeral 10 (FIG. 1) generally designates a heavy-duty truck and trailer arrangement that includes a towing vehicle such as a semi-truck or tractor 12 and a towed vehicle such as a trailer 14. In the illustrated example, the trailer 14 is supported by a dynamic vehicle suspension arrangement 16 typically associated with heavy-duty commercial vehicles and that includes a first axle arrangement 18 including a first axle member 20, and a second axle arrangement 22 including a second axle member 24. It is noted that while the instant embodiment includes the first axle member 20 as a leading axle, and the second axle 24 as a trailing axle, where the leading axle is positioned forward of the trailing axle as the truck and trailer arrangement 10 is operated in a normal forward direction. However, the embodiment as disclosed herein may also be employed with a vehicle operating in an opposite direction, and/or within a suspension arrangement wherein operation parameters from the trailing axle are monitored and utilized to control operational characteristics of the leading axle.

As best illustrated in FIG. 2, the vehicle suspension arrangement 16 includes a first mounting bracket 26 coupled to a frame rail 28 of a vehicle frame assembly 30, and a second mounting bracket 32 coupled to another frame rail 34 of the vehicle frame assembly 30. The suspension arrangement further includes a first trailing arm 36 having a first end 38 pivotably coupled to the first mounting bracket 26 and a second end 40, and a second trailing arm 42 having a first end 44 pivotably coupled to the second mounting bracket 32 and a second end 46. The second end 40 of the first trailing arm 36 and the second end 46 of the second trailing arm 42 are fixedly attached to the first axle member 20 via a weld. The suspension arrangement 16 further includes a pair of air spring arrangements including a first air spring arrangement 48 and a second air spring arrangement 50. As the first and second air spring arrangements 48, 50 are similarly configured, a description of only the first air spring arrangement 48 is provided herein. The first air spring arrangement includes an upper plate 52 located at a first end 54, a lower plate 56 located at a second end 58, and a flexible bellow 60 extending between the upper plate 52 and the lower plate 56. In the illustrated example, the upper plate 52 is attached to the corresponding frame rail 28, while the lower plate 56 is coupled to the second end 40 of the first trailing arm 36. The first end 54, the second end 58 and the bellow of the first air spring or pneumatic spring arrangement cooperate to define an interior space 62.

The first air spring arrangement 48 further includes a sensor arrangement 64 positioned within the interior space 62. The sensor arrangement 64 is configured to sense or monitor an operational parameter of the first air spring arrangement 48, as described below. The sensor arrangement 64 is operably coupled to a controller or control arrangement 66 that is configured to receive information from the first sensor arrangement and control at least one operational characteristic of the second axle member 24 based upon the information received from the first sensor arrangement 64. Although the controller arrangement 66 is illustrated as being connected to the first sensor arrangement 64 via a hard cable or wire 78, the first sensor arrangement 64 may be wirelessly coupled to the control arrangement 66.

In the illustrated example, the sensor arrangement may include any one of the plurality of a dynamic pressure sensor 68 configured to measure the pneumatic pressure within the interior space 62, a temperature sensor 70 configured to measure the temperature of the interior space 62, a single accelerometer 72 which may include a single-direction accelerometer, or a three-axis accelerometer, a pair of accelerometers including the accelerometer 72 as a first accelerometer 72 and a second accelerometer 74, and/or optical sensors 76. In the illustrated example the accelerometers 72, 74 may be configured to sense and monitor the vertical acceleration, lateral acceleration and/or fore-and-aft acceleration of the elements to which they are attached, such as the upper plate 52 and the lower plate 54. The optical sensors 76 may be configured to measure the distance between the upper plate 52 and the lower plate 56. The variously configured sensors of the first sensor arrangement 64 are adapted to sense, monitor and/or measure the dynamic state of the first axle member 20 during operation of the truck and trailer arrangement 10, thereby allowing the controller or control arrangement 66 to control the pneumatic input to air springs that support the vehicle frame assembly 30 above the second axle member 24 similar to the first air spring arrangement 48 and second air spring arrangement 50 and the first axle member 20 and optimizing movement of the second axle member 24 for improving ride quality, improving safety, increasing component life, and the like.

The operational parameter as monitored by the sensor arrangement 64 of the first air spring arrangement 48 and/or a similar sensor arrangement located within the second air spring arrangement 50 may be utilized to monitor operational parameters such as temperature, acceleration, role of the trailer 14, air pressure, weight as supported by the first axle member 20 either at one or both ends thereof, and a distance such as the distance between the upper plate 52 and the lower plate 56. The control arrangement 66 may utilize the monitored operational parameters to then calculate and/or control certain operational characteristics of the second axle member 24, such as axle loading and differential or side-to-side loading and corrections for the same, roll sensing that may include exerted forces such as weight and loading combined with monitored accelerations and corrections for the same, a torsional force exerted on the axle and corrections for the same, ride height and active jounce measurement and corrections for the same, active ride quality measurements, load reaction and control from a leading axle to one or more trailing axles, the detection of a failing air spring caused by leaks, poor response to road irregularities, accelerometer measurements for the determination of ride quality, accelerometer measurements utilized in conjunction with height or distance measurements for the controlling of jounce due to road irregularities, and the like. The operational characteristics may be controlled by adjusting damping within the air springs and/or associated shocks, adjusting air intake/exhaust from the air springs, and/or controlling the air pressure within the air springs.

The suspension arrangement as shown and described herein provides a durable suspension assembly that is efficient in use, capable of a long operating life, provides real-time feedback of suspension component operational parameters thereby allowing dynamic adjustment of operational characteristics of other components of the suspension arrangement, and is particularly well adapted for the proposed use.

In the foregoing description, it will be readily appreciated by those skilled in the art that modifications made to the disclosed embodiments without departing from the concepts disclosed herein. Such modifications are to be considered as included in the following claims, unless these claims by the language expressly state otherwise.

The invention claimed is:

1. A vehicle suspension arrangement, comprising:
a first mounting bracket and a second mounting bracket each configured to couple to a vehicle frame assembly;
a first trailing arm having a first end pivotably coupled to the first mounting bracket, and a second end;
a second trailing arm having a first end pivotably coupled to the second mounting bracket, and a second end;
a first axle member coupled to the second end of the first trailing arm and the second end of the second trailing arm;
a first air spring arrangement having a first end configured to couple to the vehicle frame assembly and a second end operably coupled to the second end of the first trailing arm, and a bellow extending between the first end and the second end, wherein the first end, the second end and the bellow cooperate to define an interior space of the first air spring arrangement;
a second axle member spaced from the first axle member;
a first sensor arrangement position within the interior space of the first air spring arrangement, wherein the first sensor arrangement is configured to sense an operational parameter of the first air spring arrangement; and
a control arrangement operably coupled to the first sensor arrangement and configured to receive information from the first sensor arrangement, wherein the control arrangement is configured to control at least one operational characteristic of the second axle member based upon the information received from the first sensor arrangement.

2. The vehicle suspension arrangement of claim 1, wherein the operational parameter includes at least one of temperature, acceleration, roll, air pressure, weight, and distance.

3. The vehicle suspension arrangement of claim 2, wherein the operation parameter includes the temperature of the interior space of the first air spring arrangement.

4. The vehicle suspension arrangement of claim 2, wherein the operational parameter includes acceleration of a portion of the first air spring arrangement in a horizontal direction.

5. The vehicle suspension arrangement of claim 2, wherein the operational parameter includes acceleration of a portion of the first air spring arrangement in a vertical direction.

6. The vehicle suspension arrangement of claim 2, wherein the operational parameter includes air pressure in the interior space of the first air spring arrangement.

7. The vehicle suspension arrangement of claim 2, wherein the operational parameter includes the weight supported by first axle member proximate the first air spring arrangement.

8. The vehicle suspension arrangement of claim 2, wherein the operational parameter includes the distance between the first end and the second end of the first air spring arrangement.

9. The vehicle suspension arrangement of claim 1, wherein the at least one operational characteristic of the second axle arrangement includes at least one of vertical acceleration, roll, and a vertical distance between the at least a portion of the second axle and the vehicle frame assembly,

10. The vehicle suspension arrangement of claim 1, further including:
a second air spring arrangement having a first end configured to couple to the vehicle frame assembly and a second end operably coupled to the second end of the trailing arm, and a bellow extending between the first end of second air spring arrangement and the second end of the second air spring arrangement, wherein the first end, the second end and the bellow of the second air spring arrangement cooperate to define an interior space of the second air spring arrangement; and
a second sensor arrangement position within the interior space of the second air spring arrangement, wherein the second sensor arrangement is configured to sense an operational parameter of the second air spring arrangement, wherein the second sensor arrangement is operably coupled to the controller arrangement and configured to send information to the controller arrangement.

11. The vehicle suspension arrangement of claim 1, wherein the controller arrangement is configured to calculate at least one of vehicle roll, a vertical load exerted on the first axle member, a differential load exerted on the first axle member, a torsional load exerted on the first axle member, a distance between the first axle member and the vehicle frame assembly, a frequency of a vertical movement of the first axle member, and an acceleration of the first axle member in at least one of a vertical direction, a lateral direction and a fore-and-aft direction.

12. The vehicle suspension arrangement of claim 1, wherein the first sensor arrangement includes an accelerometer.

13. The vehicle suspension arrangement of claim 12, wherein the accelerometer is a three-axis accelerometer.

14. The vehicle suspension arrangement of claim 1, wherein the first sensor arrangement includes a dynamic pressure sensor.

15. The vehicle suspension arrangement of claim 1, wherein the first sensor arrangement includes a temperature sensor.

16. The vehicle suspension arrangement of claim 1, wherein the first axle member is a leading axle member and the second axle member is a trailing axle member.

17. A heavy duty vehicle suspension arrangement, comprising:
a first axle member;
a first spring arrangement operably coupling a first end of the first axle member with a vehicle frame assembly;
a second axle member;
a first sensor arrangement position operably coupled to the first spring arrangement, wherein the first sensor arrangement is configured to sense an operational parameter of the first air spring; and
a control arrangement operably coupled to the first sensor arrangement and configured to receive information from the sensor arrangement, wherein the control arrangement is configured to control at least one operational characteristic of the second axle based upon the information received from the first sensor arrangement.

18. The vehicle suspension assembly of claim 17, further comprising:
a first mounting bracket and a second mounting bracket each configured to couple to a vehicle frame assembly;
a first trailing arm having a first end pivotably coupled to the first mounting bracket, and a second end;
a second trailing arm having a first end pivotably coupled to the second mounting bracket, and a second end; and
a first axle member coupled to the second end of the first trailing arm and the second end of the second trailing arm.

19. The vehicle suspension assembly of claim 18, wherein the first spring arrangement includes a first air spring arrangement having a first end configured to couple to the vehicle frame assembly and a second end operably coupled to the second end of the first trailing arm, and a bellow extending between the first end and the second end, wherein the first end, the second end and the bellow cooperate to define an interior space of the first air spring arrangement.

20. The vehicle suspension arrangement of claim 17, wherein the operational parameter includes at least one of temperature, acceleration, roll, air pressure, weight, and distance.

21. The vehicle suspension arrangement of claim 17, wherein the operational parameter includes acceleration of a portion of the first spring arrangement in a horizontal direction.

22. The vehicle suspension arrangement of claim 17, wherein the operational parameter includes acceleration of a portion of the first spring arrangement in a vertical direction.

23. The vehicle suspension arrangement of claim 17, wherein the operational parameter includes the weight supported by first axle member proximate the first spring arrangement.

24. The vehicle suspension arrangement of claim 17, wherein the operational parameter includes the distance between a portion of the first air spring arrangement and the vehicle frame assembly.

25. The vehicle suspension arrangement of claim 17, wherein the at least one operational characteristic of the second axle arrangement includes at least one of vertical acceleration, roll, and a vertical distance between the at least a portion of the second axle and the vehicle frame assembly.

26. The vehicle suspension arrangement of claim 17, further including:
a second spring arrangement operably coupling a second end of the first axle member with the vehicle frame assembly;
a second sensor arrangement position operably coupled with the second spring arrangement, wherein the second sensor arrangement is configured to sense an operational parameter of the second spring arrangement, and wherein the second sensor arrangement is operably coupled to the controller arrangement and configured to send information to the controller arrangement.

27. The vehicle suspension arrangement of claim 17, wherein the controller arrangement is configured to calculate at least one of vehicle roll, a vertical load exerted on the first axle member, a differential load exerted on the first axle member, a torsional load exerted on the first axle member, a distance between the first axle member and the vehicle frame assembly, a frequency of a vertical movement of the first axle member, and an acceleration of the first axle member in at least one of a vertical direction, a lateral direction and a fore-and-aft direction.

28. The vehicle suspension arrangement of claim 17, wherein the first sensor arrangement includes an accelerometer.

29. The vehicle suspension arrangement of claim 28, wherein the accelerometer is a three-axis accelerometer.

30. The vehicle suspension arrangement of claim 17, further comprising:
a damper arrangement operably coupled to the second axle and the vehicle frame assembly and configured to damp the movement of the second axle relative to the vehicle frame assembly, wherein the amount of damping exerted by the damper arrangement is varied by the controller.

31. The vehicle suspension arrangement of claim 17, wherein the first axle member is a leading axle member and the second axle member is a trailing axle member.
